(19) United States
(12) Patent Application Publication
(10) Pub. No.: US 2023/0390898 A1
(43) Pub. Date: Dec. 7, 2023

(54) SUBSTRATE CLAMPING APPARATUS

(71) Applicant: EBARA CORPORATION, Tokyo (JP)

(72) Inventors: Daichi KONDO, Tokyo (JP); Hisajiro NAKANO, Tokyo (JP); Mitsuru MIYAZAKI, Tokyo (JP)

(21) Appl. No.: 17/834,797

(22) Filed: Jun. 7, 2022

(51) Int. Cl. B25B 5/16

(52) U.S. Cl. CPC B25B 5/16

(57) ABSTRACT

A substrate clamping apparatus includes a substrate holding part which is movable between a closed state in which a substrate is clamped and an open state in which clamping of the substrate is released, a support column part which supports the substrate holding part and is capable of being raised and lowered, and an interlocking mechanism which interlocks a raising and lowering operation of the support column part with an opening and closing operation of the substrate holding part, in which an opening and closing operation range A of the substrate holding part in an up-and-down stroke S of the support column part includes at least a part of an intermediate region M of the up-and-down stroke S.

### BACKGROUND OF THE INVENTION

### Field of the Invention

The present invention relates to a substrate clamping apparatus.

### Description of Related Art

Japanese Unexamined Patent Application, First Publication No. 2014-133642 discloses a substrate clamping apparatus that is applicable to a washing device and a drying device for a substrate such as a semiconductor wafer. This substrate clamping apparatus includes a substrate holding part (claw) that opens and closes in conjunction with rising and lowering of a support column. In a first embodiment, the substrate holding part is operated to be opened and closed immediately before the support column stops rising. Also, in a second embodiment, the substrate holding part is operated to be opened and closed immediately after the support column starts to rise.

### SUMMARY OF THE INVENTION

However, if the substrate holding part is operated to be opened and closed in a short period of time immediately before the support column completes rising or immediately after the support column starts to rise, an opening and closing speed of the substrate holding part becomes high, an impact at the time of coming into contact with the substrate becomes large, and this leads to wear of the substrate holding part.

The present invention has been made in view of the above problems, and an objective of the present invention is to provide a substrate clamping apparatus in which wear of a substrate holding part can be suppressed.

A substrate clamping apparatus according to one aspect of the present invention includes a substrate holding part which is movable between a closed state in which a substrate is clamped and an open state in which clamping of the substrate is released, a support column part which supports the substrate holding part and is capable of being raised and lowered, and an interlocking mechanism which interlocks a raising and lowering operation of the support column part with an opening and closing operation of the substrate holding part, in which an opening and closing operation range of the substrate holding part in an up-and-down stroke of the support column part includes at least a part of an intermediate region of the up-and-down stroke.

In the substrate clamping apparatus described above, the opening and closing operation range of the substrate holding part may be 50% or more of the up-and-down stroke.

In the substrate clamping apparatus described above, the opening and closing operation range of the substrate holding part may not include a lower end of the up-and-down stroke.

In the substrate clamping apparatus described above, the opening and closing operation range of the substrate holding part may not include an upper end of the up-and-down stroke.

According to one aspect of the present invention, it is possible to provide a substrate clamping apparatus in which wear of a substrate holding part can be suppressed.

### BRIEF DESCRIPTION OF THE DRAWINGS

FIG. 1 is a longitudinal sectional view of a substrate clamping apparatus according to one embodiment.

FIG. 2 is a longitudinal sectional view of a chuck according to one embodiment.

FIG. 3 is an explanatory view for explaining a closing operation of a substrate holding part according to one embodiment.

FIG. 4 is an explanatory view for explaining movement of a substrate guide member interlocked with the closing operation of the substrate holding part according to one embodiment.

FIG. 5 is an explanatory view for explaining an opening operation of the substrate holding part according to one embodiment.

FIG. 6 is an explanatory view for explaining movement of the substrate guide member interlocked with the opening operation of the substrate holding part according to one embodiment.

FIG. 7 is a view illustrating a state in which the chuck according to one embodiment has risen to a position where a substrate is delivered.

FIG. 8 is a view illustrating a state in which the chuck according to one embodiment is in the process of rising to the position where the substrate is delivered.

FIG. 9 is an explanatory diagram for explaining timing of a raising and lowering operation and an opening and closing operation of the chuck according to one embodiment.

FIG. 10 is a graph showing timing of a raising and lowering operation of a support column part and an opening and closing operation of the substrate holding part according to one embodiment.

FIG. 11 is a graph showing timing of a raising and lowering operation of the support column part and an opening and closing operation of the substrate holding part 30 according to a modified example of one embodiment.

### DETAILED DESCRIPTION OF THE INVENTION

Hereinafter, a preferred embodiment will be described with reference to the drawings.

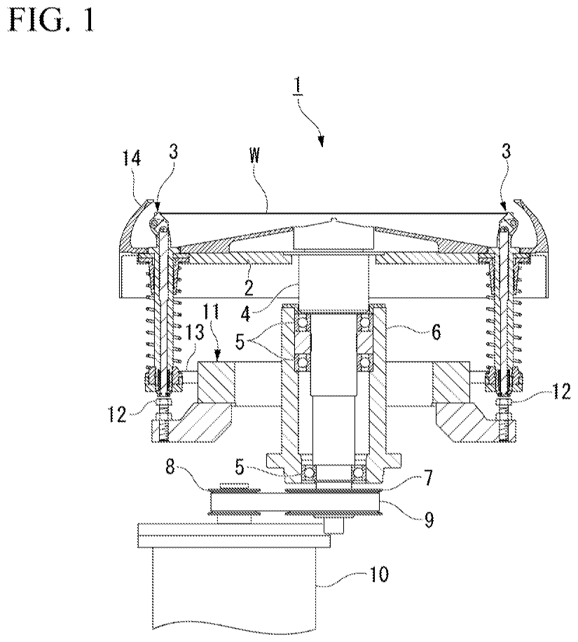

FIG. 1 is a longitudinal sectional view of a substrate clamping apparatus 1 according to one embodiment.

As illustrated in FIG. 1, the substrate clamping apparatus 1 includes a base 2, and a plurality (four in the present embodiment (two of the four are not illustrated)) of chucks 3 supported by the base 2.

The base 2 is fixed to an upper end of a rotating shaft 4. The rotating shaft 4 is rotatably supported around an axis extending in a vertical direction by a plurality of bearings 5. The plurality of bearings 5 are fixed to an inner circumferential surface of a cylindrical body 6 disposed to surround the rotating shaft 4. The cylindrical body 6 is attached to a frame (not illustrated), and a position thereof is fixed.

The rotating shaft 4 is connected to a motor 10 via pulleys 7 and 8 and a belt 9. The motor 10 rotates the base 2 via the pulleys 7 and 8 and the belt 9. The plurality of chucks 3 supported by the base 2 hold a substrate W such as a wafer. The substrate W, with a circumferential edge portion thereof held by the plurality of chucks 3, is rotated around the axis of the rotating shaft 4 by the motor 10.

A lift mechanism 11 is disposed around the cylindrical body 6. The lift mechanism 11 is slidable in the vertical direction with respect to the cylindrical body 6. The lift mechanism 11 includes a plurality of pushers 12 that come into contact with lower ends of the plurality of chucks 3 and lift the chucks 3. The lift mechanism 11 is connected to an air-driven raising and lowering device (not illustrated), and is raised and lowered together with the plurality of pushers 12.

The plurality of chucks 3 are fixed to a ring member 13. The ring member 13 raises and lowers the plurality of chucks 3 integrally in synchronization with each other. The ring member 13 extends in an annular shape in a disposition direction of the chucks 3 and is positioned below the base 2. The ring member 13, the rotating shaft 4, the base 2, and the cylindrical body 6 are concentrically disposed.

A rotating cup 14 is fixed to an upper surface of the base 2. The rotating cup 14 receives a liquid ejected from the rotating substrate W due to a centrifugal force. The rotating cup 14 is disposed to surround the entire circumference of the substrate W. A longitudinal sectional shape of the rotating cup 14 is inclined inward in a radial direction. Also, an inner circumferential surface of the rotating cup 14 is formed as a smooth curved surface.

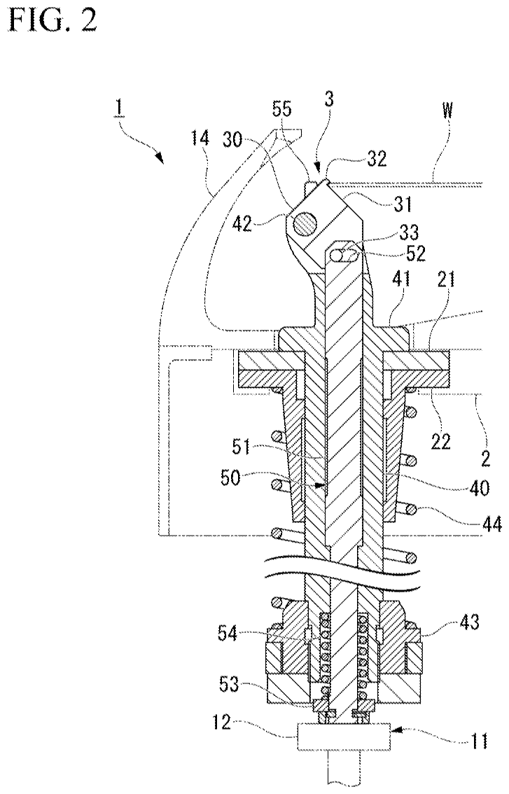

FIG. 2 is a longitudinal sectional view of the chuck 3 according to one embodiment.

The plurality of chucks 3 have the same configuration. As illustrated in FIG. 2, the chuck 3 includes a substrate holding part 30 that is movable between a closed state in which the substrate W is clamped and an open state in which clamping of the substrate W is released, a support column part 40 that supports the substrate holding part 30 and is capable of being raised and lowered, and an interlocking mechanism 50 that interlocks a raising and lowering operation of the support column part 40 with an opening and closing operation of the substrate holding part 30.

The base 2 includes a fixed plate 21 and a spring receiver 22. A through hole through which the support column part 40 is slidable in the vertical direction is formed in the fixed plate 21 and the spring receiver 22. A diameter of the through hole is slightly larger than a diameter of the support column part 40, and therefore the chuck 3 can move relative to the base 2 in the vertical direction.

The substrate holding part 30 has an inclined surface 31 having a downward gradient toward the inside of the substrate W in the radial direction. A claw part 32 that comes into contact with a circumferential edge portion of the substrate W is formed on the inclined surface 31. The circumferential edge portion of the substrate W is first placed on the inclined surface 31 and then held by the claw part 32. The substrate holding parts 30 are disposed at regular intervals around a central axis of the base 2 and the rotating shaft 4. Therefore, when the substrate holding part 30 holds the circumferential edge portion of the substrate W, it is possible to perform centering the substrate W automatically.

The support column part 40 is formed in a cylindrical shape extending in the vertical direction. The above-described ring member 13 (see FIG. 1) is fixed to the support column part 40. A flange 41 that is capable of being placed on the fixed plate 21 is provided in the vicinity of an upper end of the support column part 40. A support shaft 42 that rotatably supports the substrate holding part 30 is provided at an upper end portion of the support column part 40 above the flange 41.

A spring receiver 43 is fixed to a lower end portion of the support column part 40. A primary spring 44 is disposed between the spring receiver 22 on the base 2 side and the spring receiver 43 on the support column part 40 side. The primary spring 44 is a compression spring and biases the support column part 40 downward with respect to the base 2.

The interlocking mechanism 50 includes a rod 51 housed inside the support column part 40. The rod 51 is disposed to be movable in the vertical direction in the support column part 40. A long hole 52 is formed at an upper end portion of the rod 51. A pin 33 provided in the substrate holding part 30 is displaceably engaged with the long hole 52.

A spring receiver 53 is fixed to a lower end portion of the rod 51. A secondary spring 54 is disposed between the spring receiver 53 of the rod 51 and a step formed on an inner circumferential surface of the support column part 40. The secondary spring 54 is a compression spring and biases the rod 51 downward with respect to the support column part 40. Further, spring constants and free lengths of the primary spring 44 and the secondary spring 54 are adjusted so that the substrate holding part 30 is operated to be opened and closed at a timing to be described later.

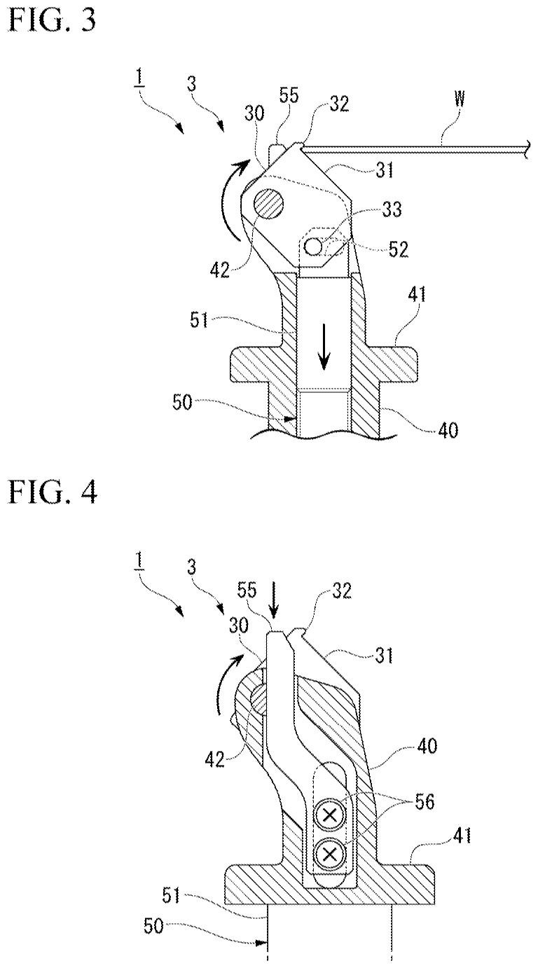

FIG. 3 is an explanatory view for explaining a closing operation of the substrate holding part 30 according to one embodiment.

As illustrated in FIG. 3, when the rod 51 is lowered relative to the support column part 40, the pin 33 engaged with the long hole 52 of the rod 51 is lowered, and thereby the substrate holding part 30 rotates with the support shaft 46 as a center. A rotation direction of the substrate holding part 30 at this time is a direction in which the claw part 32 approaches the circumferential edge portion of the substrate W. When the circumferential edge portion of the substrate W is held by the claw part 32, the substrate W is clamped.

FIG. 4 is an explanatory view for explaining movement of a substrate guide member interlocked with the closing operation of the substrate holding part 30 according to one embodiment.

As illustrated in FIG. 4, the interlocking mechanism 50 includes the substrate guide member 55 for guiding the substrate W that has been transferred from a transfer device to the substrate holding part 30. The substrate guide member 55 is fixed to the rod 51 by a screw 55. Therefore, the substrate guide member 55 vertically moves integrally with the rod 51 with respect to the support column part 40.

The substrate guide member 55 is lowered in synchronization with the closing operation of the substrate holding part 30, and an upper end thereof becomes lower than the substrate holding part 30. With such a configuration, it is possible to discharge a liquid supplied on an upper surface of the rotating substrate W from the circumferential edge portion of the substrate W by a centrifugal force without being disturbed by the substrate guide member 55. That is, it is possible to eliminate rebound of the liquid from the substrate guide member 55.

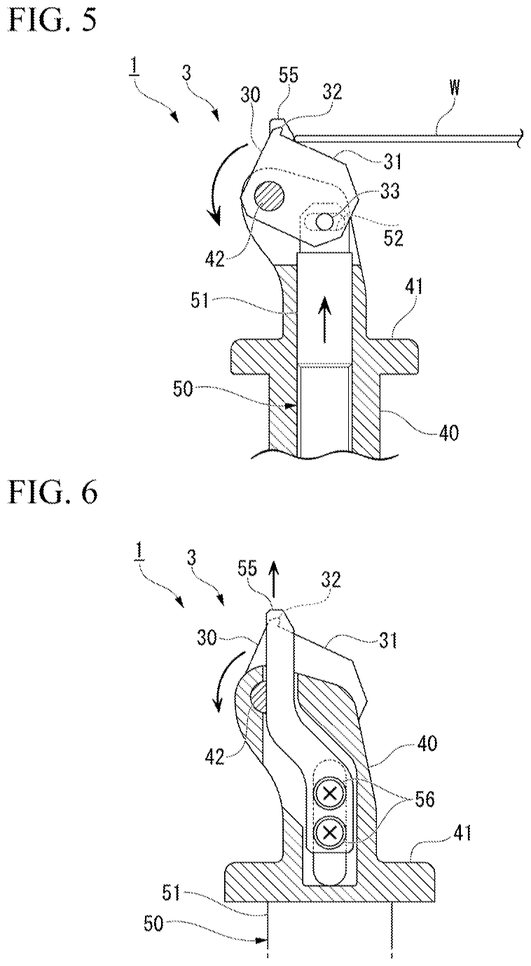

FIG. 5 is an explanatory view for explaining an opening operation of the substrate holding part 30 according to one embodiment.

As illustrated in FIG. 5, when the rod 51 rises relative to the support column part 40, the pin 33 engaged with the long hole 52 of the rod 51 rises, and thereby the substrate holding part 30 rotates with the support shaft 46 as a center. A rotation direction of the substrate holding part 30 at this time is a direction in which the claw part 32 is separated from the circumferential edge portion of the substrate W. When the claw part 32 is separated from the circumferential edge portion of the substrate W, clamping of the substrate W is released.

FIG. 6 is an explanatory view for explaining movement of the substrate guide member 55 interlocked with the opening operation of the substrate holding part 30 according to one embodiment.

As illustrated in FIG. 6, the substrate guide member 55 rises in synchronization with the opening operation of the substrate holding part 30, and the upper end thereof becomes higher than the substrate holding part 30. A tapered surface that guides the circumferential edge portion of the substrate W to the inclined surface 31 of the substrate holding part 30 is formed at an upper end of the substrate guide member 55. With such a configuration, it is possible to guide the circumferential edge portion of the substrate W delivered from the transfer device by the tapered surface of the substrate guide member 55 and to move the circumferential edge portion of the substrate W to the inclined surface 31 of the substrate holding part 30.

Next, a timing at which the substrate holding part 30 of the above configuration is operated to be opened and closed will be described.

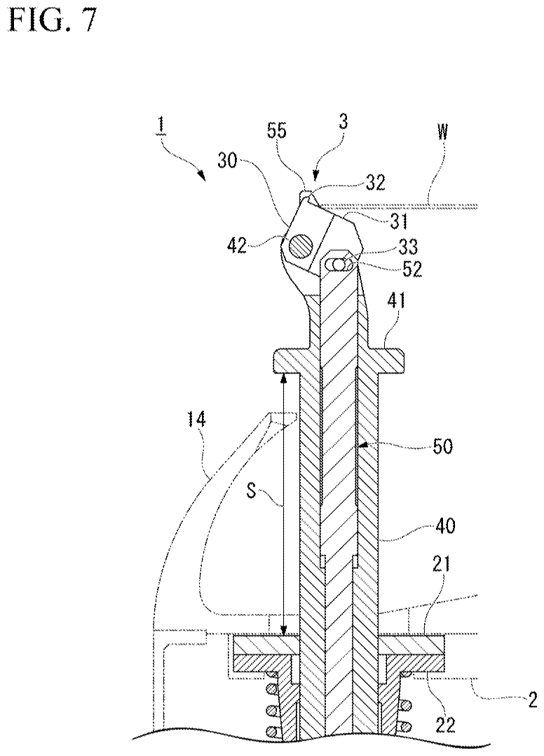

FIG. 7 is a view illustrating a state in which the chuck 3 according to one embodiment has risen to a position where the substrate W is delivered.

As illustrated in FIG. 7, when the chuck 3 rises to the position where the substrate W is delivered, the substrate holding part 30 opens. That is, the substrate holding part 30 opens at an upper end of an up-and-down stroke S of the support column part 40.

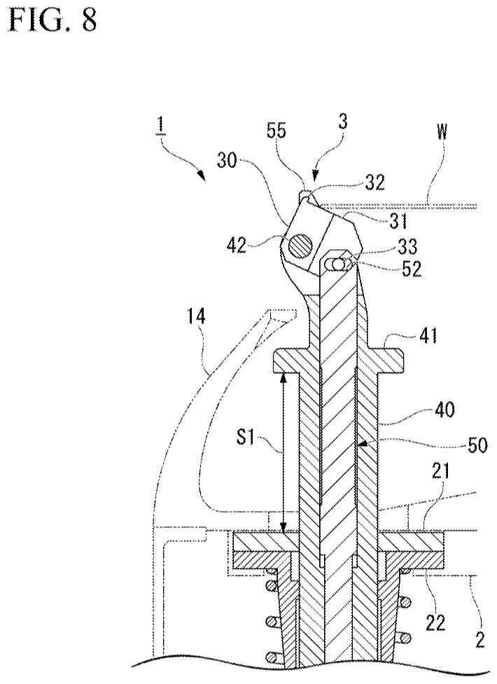

FIG. 8 is a view illustrating a state in which the chuck 3 according to one embodiment is in the process of rising to the position where the substrate W is delivered.

As illustrated in FIG. 8, the substrate holding part 30 opens while the chuck 3 is in the process of rising to the position where the substrate W is delivered. An up-and-down height S1 of the support column part 40 at this time is about 60% to 70% of the up-and-down stroke S of the support column part 40 illustrated in FIG. 7.

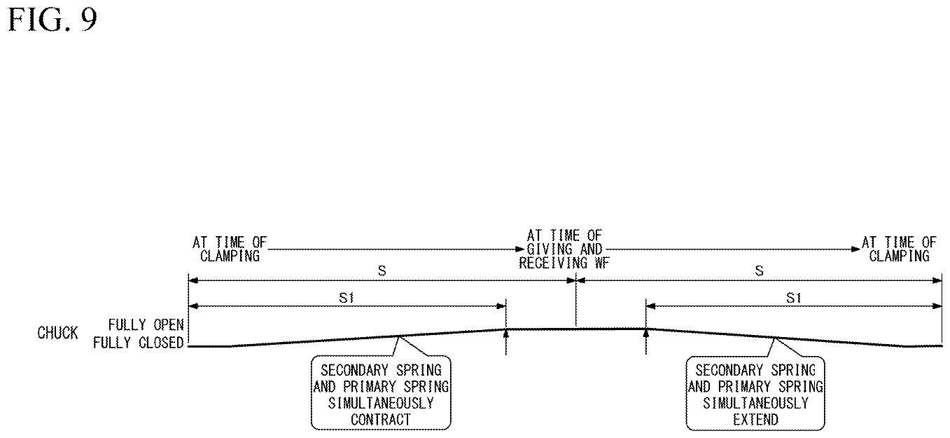

FIG. 9 is an explanatory diagram for explaining timing of a raising and lowering operation and an opening and closing operation of the chuck 3 according to one embodiment.

When the chuck 3 rises to the position where the substrate W is delivered, the pusher 12 of the lift mechanism 11 pushes up the rod 51. When the rod 51 is pushed up, an upward force is applied to the support column part 40 via the secondary spring 54. Thereby, the support column part 40 and the rod 51 rise integrally.

Positions at both ends of the line illustrated in FIG. 9 indicate a clamp position, that is, a state in which both the support column part 40 and the rod 51 are at lower end positions. At this time, a repulsive force of the primary spring 44 is slightly smaller than a repulsive force of the secondary spring 54. When the pusher 12 pushes up the rod 51, the primary spring 44 begins to contract first. That is, at this time, a length of the secondary spring 54 does not change, and the substrate holding part 30 remains in the closed state.

As illustrated in FIG. 9, at a position in which the chuck 3 is raised by X1 mm (several mm), the secondary spring 54 also begins to contract, and the primary spring 44 and the secondary spring 54 simultaneously contract from the position of X1 mm to a position of X2 mm (up-and down height S1) while the repulsive forces of the primary spring 44 and the secondary spring 54 are balanced with each other. During this time, the substrate holding part 30 gradually opens. The position of X2 mm is about 60 to 70% of the up-and-down stroke. When the chuck 3 reaches the position of X2 mm, the substrate holding part 30 is in an open state and the secondary spring 54 is fully contracted. Thereafter, only the primary spring 44 contracts, and the chuck 3 reaches the position (X3 mm (upper end of the up-and-down stroke S)) where the substrate W is delivered.

The same applies when the chuck 3 is lowered. When the chuck 3 can be lowered from the position where the substrate W is delivered to the clamp position (position of 0 mm), the pusher 12 of the lift mechanism 11 is lowered. When the pusher 12 is lowered, a downward force is applied to the support column part 40 via the primary spring 44. Thereby, the support column part 40 and the rod 51 are lowered integrally.

When the chuck 3 is lowered from the position (X3 mm) where the substrate W is delivered and reaches the position of X2 mm (the up-and-down height S1), the secondary spring 54 also begins to extend. Then, the primary spring 44 and the secondary spring 54 simultaneously extend from the position of X2 mm to the position of X1 mm. When the chuck 3 reaches X1 mm, the secondary spring 54 is fully extended and the substrate holding part 30 is in a closed state. Thereafter, only the primary spring 44 extends, and the chuck 3 reaches the clamp position (0 mm).

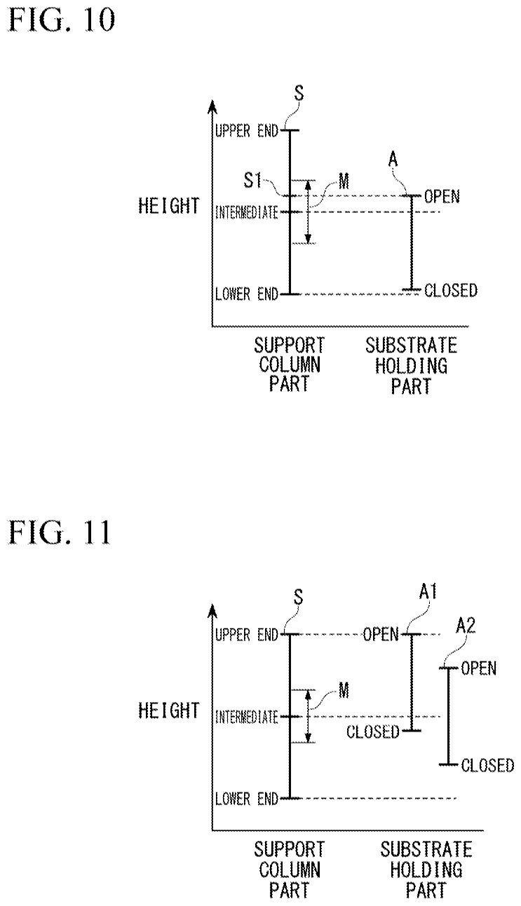

FIG. 10 is a graph showing timing of a raising and lowering operation of the support column part 40 and an opening and closing operation of the substrate holding part 30 according to one embodiment.

As shown in FIG. 10, the substrate holding part 30 is in a closed state at a lower end of the up-and-down stroke S, but gradually starts to open when the support column part 40 slightly rises from the lower end of the up-and-down stroke S. The opening and closing operation of the substrate holding part 30 is continued even past the intermediate of the up-and-down stroke S and ends when the substrate holding part 30 completely opens at a point of the up-and-down height S1 of about 60 to 70% of the up-and-down stroke S.

As described above, an opening and closing operation range A of the substrate holding part 30 in the up-and-down stroke S of the support column part 40 includes at least a part of an intermediate region M of the up-and-down stroke S. The intermediate region M means a midst region when the up-and-down stroke S is divided into three equal sections. As described above, when the substrate holding part 30 is operated to be opened and closed over a long period of time to include at least a part of the intermediate region M of the up-and-down stroke S, an opening and closing speed of the substrate holding part 30 decreases, an impact at the time of coming into contact with the substrate W is reduced, and as a result, it is possible to suppress wear of the substrate holding part 30.

As described above, the substrate clamping apparatus 1 according to the present embodiment includes the substrate holding part 30 that is movable between a closed state in which the substrate W is clamped and an open state in which clamping of the substrate W is released, the support column part 40 that supports the substrate holding part 30 and can be raised and lowered, and the interlocking mechanism 50 that interlocks a raising and lowering operation of the support column part 40 with an opening and closing operation of the substrate holding part 30, and in which the opening and closing operation range A of the substrate holding part 30 in the up-and-down stroke S of the support column part 40 includes at least a part of the intermediate region M of the up-and-down stroke S. According to this configuration, since the opening and closing operation of the substrate holding part 30 is performed over a long period of time, it is possible to suppress wear of the substrate holding part 30. Further, since the opening and closing operation of the substrate holding part 30 is performed during the raising and lowering operation of the support column part 40, even if the opening and closing operation of the substrate holding part 30 is slowed down, a throughput of the substrate processing does not decrease.

Also, in the present embodiment, the opening and closing operation range A of the substrate holding part 30 is 50% or more of the up-and-down stroke S. According to this configuration, the substrate holding part 30 is slowly operated to be opened and closed over 50% or more of the up-and-down stroke S, and thereby the opening and closing speed of the substrate holding part 30 decreases sufficiently. Therefore, an impact at the time of coming into contact with the substrate W is further reduced, and it is possible to suppress wear of the substrate holding part 30 reliably.

Also, in the present embodiment, the opening and closing operation range A of the substrate holding part 30 does not include the lower end of the up-and-down stroke S. According to this configuration, it is possible to suppress wear of the substrate holding part 30 more reliably. That is, since vibration is large immediately after the support column part 40 starts to rise, it is preferable to keep the substrate holding part 30 which is a portion coming into contact with the substrate W closed. Thereby, it possible to prevent positional deviation of the substrate W. Further, this is because there is an acceleration time before reaching a time of constant velocity immediately after the support column part 40 starts to rise, there is also influences of individual differences of parts, and thus vibration tends to be large.

Also, in the present embodiment, the opening and closing operation range A of the substrate holding part 30 does not include the upper end of the up-and-down stroke S. According to this configuration, it is possible to suppress wear of the substrate holding part 30 more reliably. That is, similarly, vibration is likely to occur when the support column part 40 starts to be lowered. When the lowering of the support column part 40 and the closing operation of the substrate holding part 30 (relative movement between the support column part 40 and the substrate holding part 30) occur, vibration is superimposed, and thus at the start of the lowering, it is preferable that only the support column part 40 is lowered while the substrate holding part 30 remains in an open state (fully open). When the substrate holding part 30 is in an open state (fully open) at the start of the lowering in which vibration is likely to occur, it can also be said that this is desirable because static friction between the substrate W and the position on which the substrate W is placed be maintained.

While preferred embodiments of the present invention have been described and illustrated above, it should be understood that these are exemplary of the present invention and are not to be considered as limiting. Additions, omissions, substitutions, and other modifications can be made without departing from the scope of the present invention. Accordingly, the present invention is not to be considered as being limited by the foregoing description and is only limited by the scope of the claims.

For example, the substrate holding part 30 may be operated to be opened and closed at the timing as illustrated in FIG. 11.

FIG. 11 is a graph showing timing of a raising and lowering operation of the support column part 40 and an opening and closing operation of the substrate holding part 30 according to a modified example of one embodiment.

As illustrated in FIG. 11, the substrate holding part 30 may have an opening and closing operation range A1 that includes at least a part of the intermediate region M of the up-and-down stroke S and operates in a latter half (upper half) of the up-and-down stroke S. Also, the substrate holding part 30 may have an opening and closing operation range A2 that includes the entire intermediate region M of the up-and-down stroke S and operates in an intermediate portion of the up-and-down stroke S.

Also, the embodiment and the modified example described above may be appropriately combined.

1. A substrate clamping apparatus comprising:
a substrate holding part which is movable between a closed state in which a substrate is clamped and an open state in which clamping of the substrate is released;
a support column part which supports the substrate holding part and is capable of being raised and lowered; and
an interlocking mechanism which interlocks a raising and lowering operation of the support column part with an opening and closing operation of the substrate holding part, wherein an opening and closing operation range of the substrate holding part in an up-and-down stroke of the support column part includes at least a part of an intermediate region of the up-and-down stroke,
wherein the substrate holding part changes to the open state while the support column part moves inside of the intermediate region, in response to the support column part moving towards an upper end of the up-and-down stroke, and
wherein the intermediate region is a midst region between three equal-sized regions where the up-and-down stroke is divided into three sections.

2. The substrate clamping apparatus according to claim 1, wherein the opening and closing operation range of the substrate holding part is 50% or more of the up-and-down stroke.

3. The substrate clamping apparatus according to claim 1, wherein the opening and closing operation range of the substrate holding part does not include a lower end of the up-and-down stroke.

4. The substrate clamping apparatus according to claim 1, wherein the opening and closing operation range of the substrate holding part does not include the upper end.

5. A substrate clamping apparatus comprising:
a substrate holding part which is movable between a closed state in which a substrate is clamped and an open state in which clamping of the substrate is released;
a support column part which supports the substrate holding part and is capable of being raised and lowered; and
an interlocking mechanism which interlocks a raising and lowering operation of the support column part with an opening and closing operation of the substrate holding part, wherein
an opening and closing operation range of the substrate holding part in an up-and-down stroke of the support column part includes at least a part of an intermediate region of the up-and-down stroke,
the substrate holding part changes to the closed state while the support column part moves on an inside of the intermediate region, when the support column part is moving towards a lower end of the up-and-down stroke, and
the intermediate region is a midst region between three equal-sized regions where the up-and-down stroke is divided into three equal sections.

6. A substrate clamping apparatus comprising:
a substrate holding part which is movable between a closed state in which a substrate is clamped and an open state in which clamping of the substrate is released;
a support column part which supports the substrate holding part and is capable of being raised and lowered; and
an interlocking mechanism which interlocks a raising and lowering operation of the support column part with an opening and closing operation of the substrate holding part, wherein
an opening and closing operation range of the substrate holding part in an up-and-down stroke of the support column part includes at least a part of an intermediate region of the up-and-down stroke,
the substrate holding part changes to the open state while the support column part moves on an outside of the intermediate region close to an upper end of the up-and-down stroke, when the support column part is moving towards the upper end,
the substrate holding part changes to the closed state while the support column part moves on an outside of the intermediate region close to a lower end of the up-and-down stroke, when the support column part is moving towards the lower end, and
the intermediate region is a midst region between three equal-sized regions where the up-and-down stroke is divided into three equal sections.
